(19) United States
(12) Patent Application Publication
(10) Pub. No.: US 2015/0364795 A1
(43) Pub. Date: Dec. 17, 2015

(54) PRELITHIATION SOLUTIONS FOR LITHIUM-ION BATTERIES

(71) Applicant: Amprius, Inc., Sunnyvale, CA (US)

(72) Inventors: Constantin Ionel Stefan, San Jose, CA (US); Irina Toulokhonova, Fremont, CA (US); Gregory Roberts, Oakland, CA (US)

(21) Appl. No.: 14/736,159

(22) Filed: Jun. 10, 2015

Related U.S. Application Data
(60) Provisional application No. 62/011,358, filed on Jun. 12, 2014.

(51) Int. Cl. H01M 10/0568; H01M 10/0525; H01M 10/0569

(52) U.S. Cl. CPC H01M 10/0568; H01M 10/0569; H01M 10/0525

(57) ABSTRACT

Prelithiation solutions for lithium-based electrochemical cells are provided. The prelithiam solutions include prelithiation salts that are configured to prelithiate the negative electrode of the electrochemical cell. Lithium ions from the prelithiation lithium salt prelithiate the negative electrode when a charging current is passed between the negative and positive electrodes. In some embodiments, the prelithiation solution may function as an electrolyte for the electrochemical cell and further includes an ion conducting lithium-based salt that is stable at the cell operating voltage. Also provided are methods of prelithiation and electrochemical cells including prelithiation solutions.

### CROSS-REFERENCE TO RELATED APPLICATION

This application claims priority to U.S. Provisional Patent Application No. 62/011,358, filed Jun. 12, 2014, which is incorporated by reference herein in its entirety and for all purposes.

### BACKGROUND OF THE INVENTION

### Field of the Invention

This invention relates generally to lithium-ion electrochemical cells, and, more specifically, to materials and methods for prelithiating same.

A lithium-ion battery stores energy by driving lithium ions from a positive electrode to a negative electrode, and the battery releases energy by transferring the lithium ions from the negative electrode to the positive electrode. Some of the lithium ions in a battery participate in side reactions that prevent them from contributing to the battery's energy storage capacity. For example, passivating electrolyte films that form on the negative and positive electrodes, which are often referred to as solid-electrolyte interphase (SEI) films, are the result of lithium-consuming side reactions. Other phenomena that can reduce the amount of lithium available for energy storage including reactions such as permanent trapping of lithium ions in the negative electrode. This can happen when the battery voltage is prohibited from going low enough on discharge to release all of the lithium stored in the negative electrode.

Such side reactions typically have their greatest effect in a battery's first cycle, with first-cycle efficiencies typically dropping to between 70%-95% for various battery chemistries. Side reactions continue throughout a battery's cycle life; yet post-first-cycle efficiencies much higher than 99% are required for most applications. Reactions of lithium ions in side reactions have the undesired effects of reducing a battery's initial capacity and reducing a battery's cycle life.

Coulombic efficiency is the ratio of the discharge capacity to the charge capacity in a particular cycle. Silicon-based negative electrodes, which are desirable because they can store more lithium per unit weight than carbon-based negative electrodes, typically have low Coulombic efficiencies in initial cycles because of side reactions and lithium-trapping effects.

Typically, the lithium inventory in a lithium-ion cell is supplied completely by lithium-containing cathode active material. Extra positive-electrode material can be added to a cell to compensate for the side reactions and other phenomena that consume or trap lithium ions. Most positive electrodes store less lithium per unit mass than most negative electrodes, and adding extra positive-electrode material reduces a cell's energy density.

### SUMMARY

In one aspect, a prelithiation solution is provided including a solvent, a lithium-based salt dissolved in the solvent to form the prelithiation solution, wherein the prelithiation solution is configured to react electrochemically at a lithium-containing positive electrode at a first voltage and wherein lithium can be removed from the positive electrode at voltages at and above a second voltage that is higher than the first voltage.

Examples of the lithium-based salt include lithium methoxide, lithium azide, lithium halides, lithium acetate, lithium acetate, lithium acetylacetonate, lithium amides, lithium acetylides, R—Li (R=alkyl and aryl), R3ELi derivatives, where E=Si, Ge, Sn and R=alkyl or aryl, and combinations thereof.

In some embodiment, the prelithiation solution further includes an ion conducting lithium based-salt that does not decompose at the first voltage. Examples of ion conducting lithium-based salts include lithium hexafluorophosphate (LiPF₆), lithium bis-trifluoromethanesulfonimide (LiTFSI), lithium bis(fluorosulfonyl)imide (LiFSI), lithium tetrafluoroborate (LiBF₄), lithium hexafluoroarsenate monohydrate (LiAsF6), lithium perchlorate (LiClO₄), lithium bis(oxalato)borate (LiBOB), lithium oxalyldifluoroborate (LiODFB), LiPF₃(CF2CF₃)₃ (LiFAP), LiBF₃(CF₂CF₃)₃ (LiFAB), LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), and combinations thereof. Examples of combinations include LiPF₆ and LiBF₄, LiPF₆ and LiN(CF₃SO₂)₂, LiBF₄ and LiN(CF₃SO₂)₂.

The solvent may be electrochemically stable at the first voltage. In some embodiments, the solvent is electrochemically stable at the second voltage. Examples of solvents include polar protic or aprotic solvents, cyclic or linear ethers, alkyl carbonates, amides, amines, esters, nitriles, gamma-butyrolactone, ionic liquids, and combinations thereof. Further examples of solvents include cyclic carbonates, lactones, linear carbonates, ethers, nitrites, linear esters, amides, organic phosphates, organic compounds containing an S═O group, and combinations thereof. The prelithiation solution may include one or more additives to increase the solubility of the lithium-based salt. The solution may have a lithium content of between about 0.01 and 25 wt %, or 0.01 and 10 wt %. In some implementations, the prelithiation solution may have a lithium content of at least 5 wt %.

Another aspect of the disclosure is a prelithiation electrolyte including a solvent; a first lithium-based salt dissolved in the solvent, wherein the first lithium-based salt undergoes a decomposition onset at a first voltage; and a second lithium-based salt dissolved in the solvent, wherein the second lithium based salt is configured to be stable at a second voltage, higher than the first voltage. In some embodiments, the second voltage is at least 0.5V greater than the decomposition onset voltage. Examples of the first lithium-based salt include lithium methoxide, lithium azide, lithium halides, lithium acetate, lithium acetate, lithium acetylacetonate, lithium amides, lithium acetylides, R—Li (R=alkyl and aryl), R3ELi derivatives, where E=Si, Ge, Sn and R=alkyl or aryl, and combinations thereof.

Examples of the second lithium-based salt include (LiPF₆), lithium bis-trifluoromethanesulfonimide (LiTFSI), LiFSI, lithium tetrafluoroborate (LiBF₄), lithium hexafluoroarsenate monohydrate (LiAsF6), lithium perchlorate (LiClO₄), lithium bis(oxalato)borate (LiBOB), lithium oxalyldifluoroborate (LiODFB), LiPF₃(CF2CF₃)₃ (LiFAP), LiBF₃(CF₂CF₃)₃ (LiFAB), LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), a lithium salt having a cyclic alkyl groups, and combinations thereof.

Another aspect of the disclosure relates to a method of prelithiating an electrochemical cell, including providing an anode configured to absorb lithium ions, a cathode, and a separator disposed between the anode and the cathode; soaking the separator with a prelithiation solution; and providing a first voltage between the anode and the cathode to thereby decompose the lithium-based salt and provide lithium ions to the anode.

Example anode active material include carbon, silicon, silicides, silicon alloys, silicon oxides, silicon nitrides, germanium, tin, titanium oxide, and combinations thereof.

In some embodiments, the cathode includes lithium where lithium can be removed from the cathode at voltages at and above a second voltage where the first voltage is lower than a second voltage. Examples of cathode active materials include lithium iron phosphate (LFP), LiCoO₂, LiMn₂O₄, lithium nickel cobalt aluminum oxide (NCA), and lithium nickel cobalt manganese oxide (NCM). In some embodiments, the method includes bringing electrochemical cell to its operating voltage without first removing the prelithiation solution.

Another aspect of the disclosure is a preassembled lithium-ion electrochemical cell including an anode, a cathode, a separator disposed between the anode and the cathode, a package containing the anode, the cathode, and the separator, the package having an opening through which a liquid can be poured, and a prelithiation solution, the solution soaked into at least the separator.

The foregoing aspects and others will be readily appreciated by the skilled artisan from the following description of illustrative embodiments when read in conjunction with the accompanying drawings.

### BRIEF DESCRIPTION OF THE DRAWINGS

FIG. 1 is a schematic drawing that shows the main components of a lithium-ion electrochemical cell.

FIG. 2 is a schematic illustration that shows the basic mechanisms at work in a prelithiation process, according to various embodiments.

FIG. 3 is a flow chart that shows certain operations involved in prelithiation using a prelithiation solution according to various embodiments.

FIG. 4A is a graph that shows the capacity delivered to cells with a prelithiation solution and to cells with a conventional electrolyte under the same protocol.

FIG. 4B is a graph that shows the carbon negative-electrode potential (vs. Li/Li⁺⁾ after the prelithiation protocol for both cells with a prelithiation solution and for cells with a conventional electrolyte.

FIG. 5 illustrates an example prelithiation-charging protocol.

FIG. 6 shows anode potential versus a Li/Li+ reference electrode in a three electrode cell during the first constant current charge (also referred to as formation) in a standard electrolyte and in a prelithiation electrolyte.

### DETAILED DESCRIPTION

Prelithiation is a process that adds lithium to a negative electrode before cell production is complete, inserting additional lithium into the cell beyond that which is contained in the positive electrode. Negative electrodes can be prelithiated before cell assembly. For example, lithium metal can be mixed with an active material when an electrode is fabricated, although this may add cost and make an electrode more difficult to process and to handle. Anodes can also be prelithiated after cell assembly. For example, a lithium metal electrode can be temporarily inserted into a cell in an electrochemical circuit with the negative electrode. Current can be passed between the lithium metal electrode and the negative electrode to prelithiate the negative electrode. In commercial cell designs with jelly-rolled or stacked electrodes, this is not particularly practical because most of the negative electrode is not easily accessible.

Lithium in negative electrodes has a high thermodynamic activity, so that it is highly reactive and potentially dangerous to handle. Some prelithiation methods are performed before cell assembly. But, because of the issues with lithium, electrodes prelithiated before cell assembly add extra safety risks and handling costs. Methods to prelithiate cells with auxiliary electrodes after cell assembly cannot achieve adequate current distributions for uniform charge storage in multi-layer (commercial) cells. Various embodiments of the invention, as disclosed herein, describe a cost-effective and practical prelithiation method that can be performed in an assembled cell without an auxiliary electrode.

In some embodiments, an economical, easily manufacturable, and scalable approach to prelithiate negative electrodes in Li-ion cells is provided. One or more of the following advantages may be present in the solutions, methods and electrochemical cells described herein. In certain embodiments, prelithiation using the solutions disclosed herein may be safer than the use of lithium metal powder. In certain embodiments, prelithiation may be performed in a manner that is fairly simple. This may be less expensive and easier to implement than processes that use an auxiliary electrode or prelithiate before cell assembly (for example via a separate electroplating bath or by transferring lithium from a lithium foil). In certain embodiments, the prelithiation solutions and methods described herein may be implemented with a wide variety of anode architectures such that the anode architecture is not limited by the prelithiation process.

In this disclosure, the terms “negative electrode” and “anode” are both used to mean “negative electrode.” Likewise, the terms “positive electrode” and “cathode” are both used to mean “positive electrode.”

In this disclosure, the term “prelithiation solution” is used to mean a solution that contains prelithiation salts and can be used to add lithium to an anode in an electrochemical reaction before normal operation of an electrochemical cell. The term “prelithiation solution” may be used interchangeably with the term “prelithiation electrolyte.” The term “standard electrolyte” is used to mean the electrolyte that contains Li-ion conductive salts and is used in the normal cycling operation of an electrochemical cell. In some embodiments, a prelithiation solution including Li-ion conducting salts can also perform as a standard electrolyte.

While the description chiefly refers to lithium ion batteries, the prelithiation solutions and methods may be advantageously used with any electrochemical cell that may be enhanced or enabled by adding lithium to one of the electrodes. These may include capacitors, supercapacitors, and other storage devices.

In one embodiment of the invention, an electrolytic solution made specifically for prelithiation is described. The prelithiation solution contains a lithium salt dissolved in a solvent or solvents that are compatible with lithium-ion electrode materials, such as those listed below. In one arrangement, the solvent or solvents are stable over the entire voltage range of the prelithiation process. In another arrangement, the solvent or solvents oxidize at the cathode. The oxidation produces no reaction products that are harmful to the functioning of either the prelithiation process or normal cell operation. It is preferred that the solvent or solvents are not reduced at the anode, as such a reaction would compete with the lithium insertion process and may adversely affect the prelithiation.

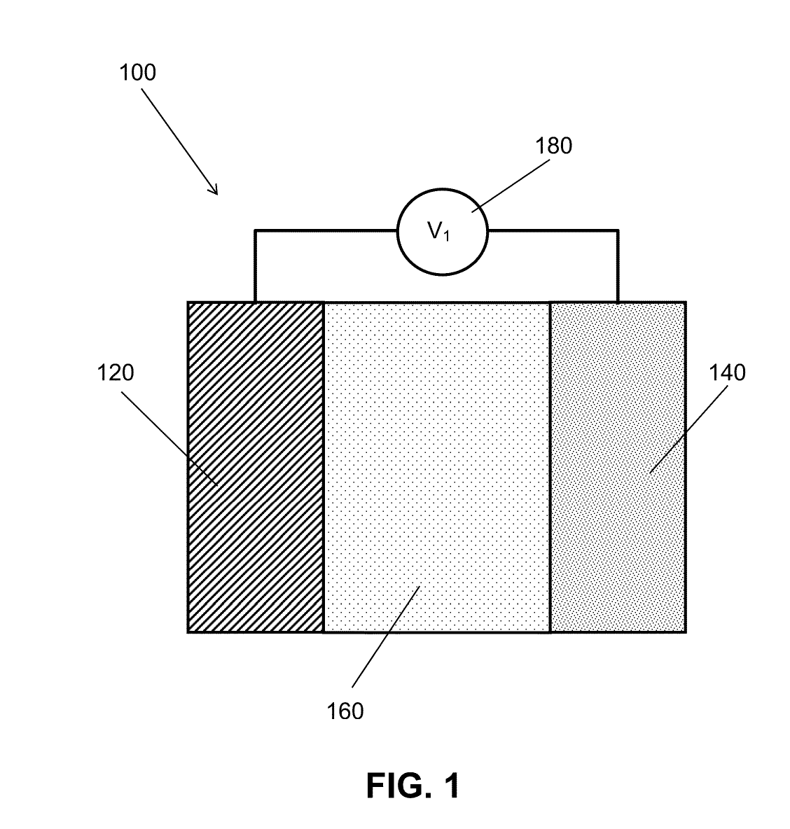

The prelithiation solution can be used to prelithiate an anode in a lithium-ion electrochemical cell such as the one shown in the schematic drawing in FIG. 1. An electrochemical cell 100 has an anode 120, a lithium-containing cathode 140 and a separator 160. No electrolyte has been added to the separator 160. A prelithiation solution is added to the separator 160. In one arrangement, a constant prelithiation voltage V₁ 180 is applied between the anode 120 and the cathode 140 (constant voltage or CV method). The prelithiation voltage V₁ may be lower than the voltage V₂ at which the cell will operate once assembly is complete. At voltage V₂ lithium is removed from the lithium-containing active material in the cathode 140, so that it can move to the anode 120. If V₁ is less than the cell operating voltage, no lithium is released from the cathode 140. In another arrangement, a constant current is passed between the anode 120 and the cathode 140 (constant current or CC method). The voltage arising from the current may be lower than the voltage V₂ at which the cell will operate once assembly is complete. In one arrangement, the charging rate is between 1C and C/20 or between 1C and C/10. It may be useful to charge at the fastest rate possible without damaging the cell. In other embodiments, multiple steps, some involving constant voltage and some involving constant current, are used in the prelithiation method. The voltage (CV) or current (CC) may be monitored and controlled carefully.

In one embodiment, the cathode does not contain lithium. In this case, there is more freedom in the choice of voltage at which to do prelithiation as there is no concern about removing lithium from the cathode.

In one arrangement, the prelithiation is performed at room temperature. It may be desirable to increase the temperature to increase salt solubility or improve the kinetics of the process. It may be undesirable to increase the temperature to a point where the solvent vaporizes or other components of the cell, such as the separator, begin to break down. In one arrangement, the prelithiation is performed at a temperature between about 30° C. and 100° C., or between about 30° C. and 75° C.

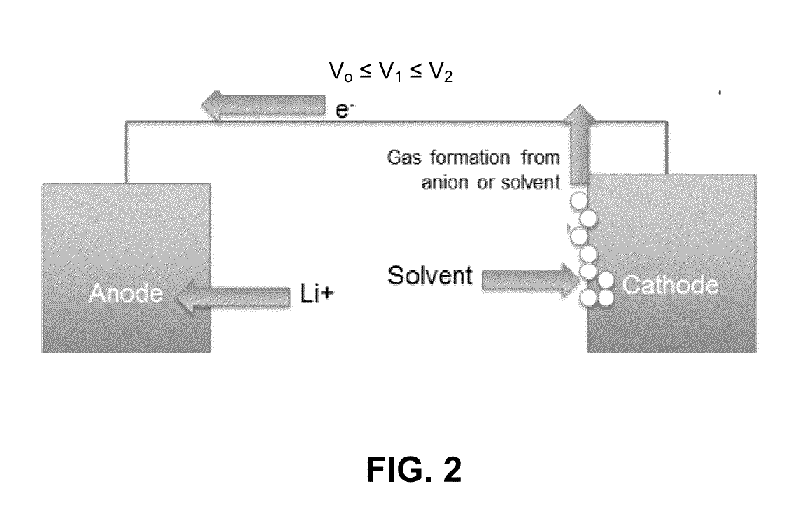

As shown in FIG. 2, at a voltage V₁, the lithium salt in the prelithiation solution dissociates in a reaction at the cathode. In one embodiment of the invention, the reaction produces Li⁺ ions and a gas. The Li⁺ ions move through the separator 160 and are absorbed in the anode 120. The gas is released from the cell. The voltage V₁ is between or equal to voltages Vₒ and V₂ and may be constant or varied, Vₒ being the decomposition onset voltage of the prelithiation salt and V₂ being the cell charging voltage. It should be noted that Vₒ and V₂ are cathode dependent, with each cathode material and type having its own specification. In some embodiments, a difference between V₂ and Vₒ may be about at least about 0.3V or 0.5V. In some embodiments, a difference between V₂ and Vₒ may be 2V or higher.

In one example according to FIG. 2, the cell is prelithiated in a current control protocol with voltage limits as above. The current can be controlled at different levels between Vₒ and V₂. In this case, the prelithiation process may proceed before and during the first charging of the cell (sometimes called cell formation). If the prelithiation electrolyte solvents are stable at least to voltage V₂ and the prelithiation salt is fully consumed during the prelithiation-formation protocol, the remaining electrolyte solution may not have to be replaced with a new electrolyte solution for normal cell operation but can be used with an electrolyte salt as the operating cell electrolyte.

According to various embodiments, the prelithiation solution contains a prelithiation salt, which is a lithium salt that decomposes at a voltage lower than the cell operating voltage. In various embodiments, the prelithiation solution has between 0.01% and 25 wt % lithium. For example, the prelithiation solution may have between 10% and 25% lithium, or between about 10 and 20% lithium, or 10% to 15% lithium. In another example, the prelithiation solution has between 0.01% and 15 wt % lithium, or between 0.01 and 10 wt % lithium. It will be understood that such concentrations can be achieved by appropriate combinations of lithium salt content and salt solubility in the solvent or solvents.

The amount of lithium will also depend on if the prelithiation solution is to be used as a standard operating electrolyte for the electrochemical cell. As described below, in some embodiments, the prelithiation solution functions as or is mixed with an electrolyte that includes one or more Li-containing, ion conducting, electrolyte salts. In such embodiments, the prelithiation solution may have between 5% to 25 wt % lithium. In embodiments in which the prelithiation solution does not include typical electrolyte salts, the prelithiation solution may have between 0.01% to 10% wt lithium.

The prelithiation Li salt is a source of lithium for the negative electrode. This is unlike Li salts used in typical Li ion battery electrolytes, which are stable ion conductors that are not designed to be consumed during cell operation. By contrast, the prelithiation Li salt is one that will decompose at voltages lower than the voltage at which Li comes out of the cathode (typically V₂).

In general, any such lithium salt that can be dissolved in a process-compatible solvent can be used. Examples of pre-lithiation salts are lithium methoxides, lithium azides, lithium halides (e.g., LiF, LiCl, and LiBr), lithium acetates, lithium acetylacetonates, lithium amides, lithium acetylides, R—Li derivatives where R=alkyl or aryl, and R₃ELi derivatives, where E=Si, Ge, Sn and R=alkyl or aryl and combinations thereof. Specific examples of R include methyl, ethyl, propyl, iso-propyl, butyl, tert-butyl, phenyl, tolyl, o-tolyl, mesityl, diphenylmethyl, triphenylmethyl, and (hydroxymethyl)diphenylmethyl. Examples of R—Li prelithiation salts include biphenyllithium, dilithiumbiphenyl, and substituted biphenyl lithium derivatives, such as 1,3-diphenylbiphenyl dilithium salt. Examples of R for R₃Li include methyl, ethyl, propyl, iso-propyl, butyl, tert-butyl, biphenyl, naphthyl, and combinations thereof. It should be noted that these salts are not typically found in lithium ion battery electrolytes as they decompose at typical cell operating voltages. Further, Li salts that decompose at higher voltages (including those that may be found in Li ion battery electrolytes) may be used in certain applications in which the cell operating voltage V₂ is high.

In some embodiments, the prelithiation solution also functions as the electrolyte of the cell. In such embodiments, the prelithiation solution may contain both a prelithiation Li salt and an ion conducting salt. Examples of ion conducting salts include lithium hexafluorophosphate (LiPF₆), lithium bis-trifluoromethanesulfonimide (LiTFSI), lithium bis(fluorosulfonyl)imide (LiFSI), lithium tetrafluoroborate (LiBF₄), lithium hexafluoroarsenate monohydrate (LiAsF6), lithium perchlorate (LiClO₄), lithium bis(oxalato)borate (LiBOB), lithium oxalyldifluoroborate (LiODFB), LiPF₃(CF2CF₃)₃ (LiFAP), LiBF₃(CF₂CF₃)₃ (LiFAB), LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), and combinations thereof. Examples of combinations include LiPF₆ and LiBF₄, LiPF₆ and LiN(CF₃SO₂)₂, LiBF₄ and LiN(CF₃SO₂)₂.

Prelithiation electrolytes thus may have two types of salts: one or more prelithiation salts and one or more ion conducting salts, the prelithiation salt(s) being more unstable and decomposing at lower voltages than the ion conducting salt(s). It should be understood that the prelithiation salt(s) are generally consumed during the prelithiation process while the ion conducting salt(s) remain in the prelithiation electrolyte during subsequent cell cycling to conduct ions. Ion conducting salts may also be employed in situations in which the electrolyte will be changed after prelithiation to boost conductivity during prelithiation.

Examples of process-compatible solvents that can be used in the prelithiation solution described herein include, but are not limited to polar protic or aprotic solvents, cyclic or linear ethers (including dioxolanes, dioxanes, glymes, and tetrahydrofuran), amides, amines, esters, alkyl carbonates, nitriles, esters like gamma-butyrolactone, ionic liquids, hydrocarbons, and combinations thereof.

In some embodiments, the solvent is suitable as a solvent for an operating lithium ion battery. Examples of non-aqueous solvents suitable for some lithium ion cells include the following: cyclic carbonates (e.g., ethylene carbonate (EC), propylene carbonate (PC), butylene carbonate (BC) and vinylethylene carbonate (VEC)), linear carbonates (e.g., dimethyl carbonate (DMC), methyl ethyl carbonate (MEC), diethyl carbonate (DEC), methyl propyl carbonate (MPC), dipropyl carbonate (DPC), methyl butyl carbonate (NBC) and dibutyl carbonate (DBC)), fluorinated versions of the cyclic and linear carbonates (e.g., monofluoroethylene carbonate (FEC)) lactones (e.g., gamma-butyrolactone (GBL), gamma-valerolactone (GVL) and alpha-angelica lactone (AGL)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), organic compounds containing an S═O group (e.g., dimethyl sulfone and divinyl sulfone), and combinations thereof.

Non-aqueous liquid solvents can be employed in combination. Examples of the combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In one embodiment, a cyclic carbonate may be combined with a linear ester. Moreover, a cyclic carbonate may be combined with a lactone and a linear ester.

One or more additives may be used to increase solubility of the prelithiation salt. Examples of additives that can improve salt solubility include aza-ethers (e.g., (diaza[12]crown-4), crown ethers (e.g. 12-crown-4), triacetyl-β-cyclodextrin, boric acid esters, and boron-based anion receptors with various fluorinated and non-fluorinated aryl and alkyl groups. Anion receptors can be added to the prelithiation solution to increase lithium salt solubility. Examples of anion receptors that can be used in the prelithiation solution described herein include, but are not limited to, tris(pentafluorophenyl)borane, triphenylborane, tris(3,5-bis(trifluoromethyl)phenyl)borane, boron trifluoride complexes with pyridines, pyrroles and tertiary amines, tris(pentafluorophenyl)borate, pentafluorophenylboronoxalate, 2-(pentaflurophenyl)-tetrafluoro-1,2,3-benzodioxoborole, boron containing polymeric Lewis acids (e.g. poly[4-bis(pentafluorophenyl)borylstyrene]), polysilicones grafted with boron containing Lewis acids, phosphates, phosphines, amides, thioamides, ureas, thioureas, pyrroles, pyridines, and combinations thereof.

Additional additives that may be used to increase the solubility of the prelithiation salts include boron-containing compounds, phosphorus-containing compounds, sulfur-containing compounds, nitrogen-containing compounds, halogen-containing compounds, acid anhydrides, oxalates, aromatic derivatives, and carbonates.

Examples of boron-containing compounds that may be used to increase the solubility of the prelithiation salt include BF3, lithium bis(1,2-benzenediorate(2)-O, O′)borate, lithium bis(2,3-naphtalenediolato)borate, lithium bis[3-fluoro-1,2-benzenediolato(2-)-O,O′]borate, lithium bis(oxalate)borate, and lithium difluoro(oxalate)borate.

Examples of phosphorous-containing compounds that may be used to increase the solubility of the prelithiation salt include lithium fluorophosphates containing fluorinated alkyl and aryl groups, such as lithium tris(pentafluoroethyl)trifluorophosphate, lithium fluorophosphates (Li2PO3F), lithiumdifluorophosphate (LiPO2F2), lithium tetrafluoro(oxalo)phosphate and lithium difluorobis(oxalo)phosphate, tris(trimethylsilyl)phosphate, tris(trimethylsilyl)phosphite, tris(2-ethylhexyl)phosphate, triphenyl phosphite, triethyl phosphate, triallylphosphate, tripropargylphosphate, ethyldiethylphosphinate, diphosphinates, such as 1,4-butanediol bis(diethylphosphinate), as well as cyclic phosphates, such as 2-ethoxy-1,2-oxaphospholane 2-oxide, hexapropioxycyclotriphosphazenem, and hexafluoroethoxycyclotriphospazene.

Examples of sulfur-containing compounds that may be used to increase the solubility of the prelithiation salt include thiophenes, diphenylsulfide, diphenyldisulfide, di-p-tolyldisulfide, bis(4-methoxyphenyl) disulfide, 4,4′-dimethoxydiphenylsulfide, 1,2-bis(p-methoxyphenylthio)ethane, methyl oxo(phenylthio)acetate, S,S′-diphenyl dithiooxalate, S-phenyl O-methyl thiocarbonate, S,S-diphenyl dithiocarbonate, thiophene and its derivatives, cyclic sulfonates (sultones), such as 1,4-butane sultone, 1,3-propane sultone, 3-hydroxypropanesulfonic acid, 1,3-propene sultone, prop-1-ene-1,3-sultone, cyclic alkylenedisulfonic acid esters, such as methylene methanedisulfonate, ethylene methanedisulfonate, 1,5-dioxa-2,4-dithian-6-one-2,2,4,4-tetraoxide, chain sulfonates, such as ethyl methanesulfonate, diolesulfonates, such as 1,4-butanediol dimethanesulfonate, 1,3-butandiol dimethylsulfonate, propargyl methanesulfonate, 2-butyne-1,4-diol dimethansulfonate, fluorine substituted chain disulfonates, such as 1,4-butanediol bis(trifluoromethanesulfonate), triol trisulfonates, such as 1,2,4-butantriol trimethanesulfonate, chain alkyl disulfonates, such as dimethylmethanedisulfonate, diethyl methanedisulfonate, diphenyl methanedisulfonate; cyclic sulfites, such as ethylene sulfite, dipropargyl sulfite; sulfates, such as vinylene sulfate, ethylene sulfate, chain sulfates, such as diallylsulfate, benzyl methyl sulfate, silicon containing sulfates, such as bis(trimethylsilyl)sulfate, dipropargyl sulfate.

Examples of nitrogen-containing compounds that may be used to increase the solubility of the prelithiation salt include N-methylpyrrolidone, N,N-dimethylacetamide, bis(N-succinimidyl carbonate, benzyl N-succinimidyl carbonate, N-hydroxysuccinimide, succinimide, maleimide, N-vinyl-ε-caprolactam, pyrrole, N-methylpyrrole, pyridine, 1-phenylpiperazine, 1,2,3,4-tetrahydroisoquinoline, 10-methylphenothiazine, dinitriles, such as adiponitrile, succinonitrile, sebaconitrile and glutaronitrile.

Examples of halogen-containing compounds that may be used to increase the solubility of the prelithiation salt include fluoroethylene carbonate (FEC), chloroethylene carbonate (CEC), trifluoromethyl ethylene carbonate, methyl pentafluorobenzoate, methyl 2,6-difluorobenzoate, pentafluorophenyl methansulfonate, methyl pentafluorophenyl carbonate, fluorobenzene, 1,2-difluorobenzene, 1,3,5-trifluorobenzene, 2-fluorobiphenyl, 1-bromo-4-tert-butylbenzene, 1-fluoro-2-cyclohexylbenzenr, 1-fluoro-3-cyclohexylbenzene, 1-fluoro-4-cyclohexylbenzene, methyl difluoroacetate, methyl perfluorobutyrate, 2-fluorotoluene, and 3-fluorotoluene.

Examples of acid anhydrides that may be used to increase the solubility of the prelithiation salt include methansulfonic anhydride, 1,2-ethanedisulfonic anhydride, 3-sulfopropionic anhydride, 2-sulfobenzoic anhydride, succinic anhydride, maleic anhydride, benzoic anhydride, and acetic anhydride.

Examples of oxalates that may be used to increase the solubility of the prelithiation salt include dipropargyl oxalate, methyl propargyloxalate, ethylmethyl oxalate, and diethyl oxalate.

Examples of aromatic derivatives that may be used to increase the solubility of the prelithiation salt include biphenyl, 1,2-diphenylbenzene, 1,2-diphenylethane, diphenylether, 1,3,5-trimethoxybenzene, 2,6-dimethoxytoluene, 3,4,5-trimethoxytoluene, 2-chloro-p-xylene, 4-chloroanizole, 2,4-difluoroanisole, 3,5-difluoroanisole, 2,6-difluoroanisole, 3-chlorothiophene, furan, cumene, cyclohexylbenzene, trimellitates, such as tris(2-ethylhexyl)trimellitate, 2,2-diphenylpropane, 4-acetoxybiphenyl, 1,2-diphenoxyethane, diphenoxybenzene, terphenyl compounds, such as o-terphenyl, m-terphenyl, p-terphenyl, hexaphenylbenzene, 1,3,5-triphenylbenzene, dodecahydrotriphenylene, divinyl benzene, 1,4-dicyclohexylbenzene, tert-butyl benzene compounds such as, tert-butylbenzene, 4-tertbutyltoluene, 1,3-ditert-butylbenzene, tert-amylbenzene, triphenylene, and 2,5-di-tert-butyl-1,4-dimethoxybenzene.

Examples of carbonates that may be used to increase the solubility of the prelithiation salt include vinyl carbonate and vinyl ethylene carbonate.

In addition to additives used to increase the solubility of the prelithiation salt, a prelithiation solution may contain one or more additives for other purposes, e.g., to control SEI layer formation or to boost conductivity. Examples of additives include vinylene polymerizable additives (e.g., vinylene carbonate, vinyl ethylene carbonate) furan polymerizable additives (e.g., furan, cyanofuran), isocyanates polymerizable additives (e.g., phenyl isocyanates).

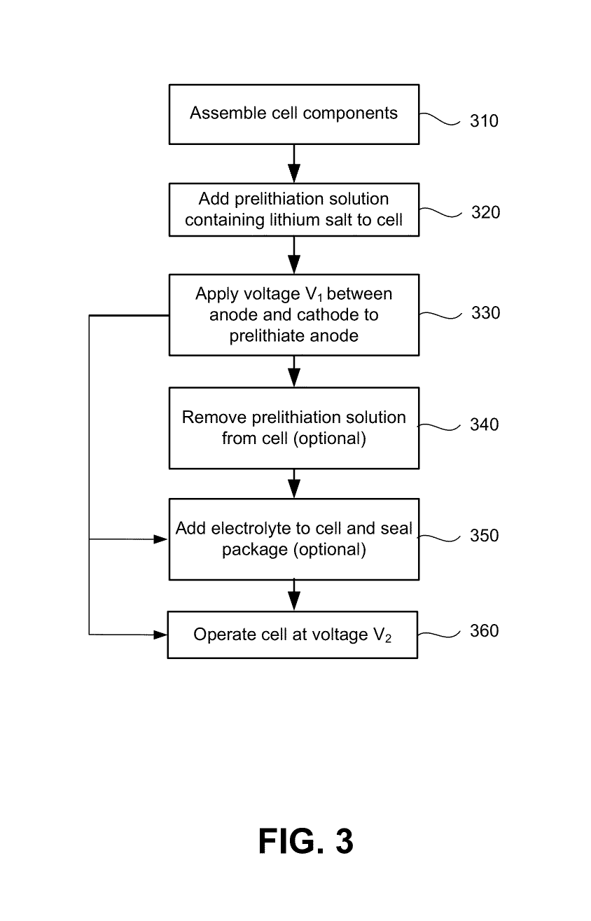

FIG. 3 is a process flow diagram showing certain operations in an example of a method of prelithiation using a prelithiation solution as described herein. At 310, components of an electrochemical cell are assembled. These components generally include the anode, cathode, and separator. Other components of the cell may or may not be added at 310. This may depend in part whether the cell is sealed in a package after the prelithiation solution is added.

At 320, a prelithiation solution that contains lithium salt and a solvent, according to an embodiment of the invention, is added to the cell. Enough solution may be added such that the separator is saturated. The lithium salt is a prelithiation salt as described above. According to various embodiments, the prelithiation solution may also contains one or more ion conducting salts as described above. In some embodiments, a prelithiation solution as described above may be mixed with a standard electrolyte.

At 330, a prelithiation voltage V₁ is applied between the anode and the cathode. The prelithiation voltage V₁ is sufficient to cause the lithium salt to undergo an electrochemical dissociation reaction at the cathode. In some embodiments, the prelithiation voltage V₁ is not high enough for the solvent in the prelithiation solution to oxidize. In another arrangement, the solvent may oxidize as long are there are no harmful reaction products.

The applied voltage V₁ may be constant or varied. During operation 330, the prelithiation salt acts as a lithium source, with lithium ions from the decomposed lithium salt providing lithium to the anode. In some embodiments, voltage V₁ is not high enough that lithium is removed from the cathode. However, in some embodiments, all or part of the prelithiation process may occur during cell formation cycles or charging of the cell. In such cases, V₁ may be set equal to V₂ during some or all of operation 330.

Operation 330 may proceed until the desired amount of prelithiation is reached, and can be monitored by measuring the electrical charge passed through the system. As the reaction proceeds, gas may be evolved as a reaction product at the cathode. In some embodiments, the gas escapes from the cell through an opening in the package.

In some embodiments, the prelithiation salt is consumed during the prelithiation protocol and prior to any formation cycles. As noted above, however, in some embodiments, prelithiation may continue or take place entirely during formation cycles or initial charging of the cells. The prelithiation salt may be consumed during the prelithiation-formation protocol. During cell formation, an SEI layer may form on the negative electrode. Examples of cell formation cycling protocols may be found in U.S. Pat. No. 8,801,810, incorporated by reference herein for the purpose of describing formation cycles, though any appropriate protocol may be used. The prelithiation salt is typically consumed during the prelithiation-formation protocol, if employed. It some embodiments, the electrolyte is replaced after a prelithiation-formation protocol is performed.

In some embodiments, an optional operation 340 in which the prelithiation solution is removed from the cell is performed. In one arrangement, the solution is actively removed by pouring out, and/or by applying a vacuum to the package to extract the solution. In another arrangement, the solution is passively removed by allowing it to evaporate from the cell. Heat may be applied to accelerate the evaporation as long as the temperature is not high enough to damage any of the cell components. Combinations of active and passive removal may be used. Operation 340 may be performed, for example, if the solvent or decomposition byproducts in the prelithiation solution after prelithiation are reactive at the cell operation voltage V₂. However, in embodiments in which the prelithiation solution is an operating cell electrolyte, operation 340 is generally not performed.

At optional operation 350, an electrolyte is added to the cell. Operation 350 may be performed in embodiments in which the prelithiation solution does not also function as the standard operating cell electrolyte. It may be performed after the prelithiation solution is removed, or in some embodiments, an electrolyte may be added to the cell after operation 330. In some embodiments, the cell may be removed from the package and placed into a new package before the electrolyte is added. In some embodiments, this removal may be performed as or after the prelithiation solution is removed in operation 340. If not already performed, the package may be sealed after operation 350 (or after operation 330 and/or 340 if operation 350 is not performed).

Even in embodiments in which the prelithiation solvent is removed, some residual amounts of salt or solvent may be present in the sealed cell. As such, it is especially useful if prelithiation salts and solvents chosen so that the battery is tolerant of and functional with residual amounts of salt or solvent that are not removed. At 360, the cell is fully assembled and it may be operated at its specified voltage V₂. As discussed above, according to various embodiments, at least a portion of (and in some embodiments all) of operation 330 may overlap with operation 360. However, in some embodiments, operation 330 may be complete, with the prelithiation salt consumed prior to operation 360. If the electrolyte is replaced, one or more cell formation cycles may be performed with the new electrolyte.

In some embodiments, the battery is charged directly to its operating voltage after the prelithiation protocol. Measures may be taken to mitigate the effects of any prelithiation byproducts. These can include venting gases and replacing the prelithiation solution with an electrolyte. If gases are vented, the cell may be in an environment where the amount of moisture is low.

The prelithiation voltage V₁ may be chosen carefully. As discussed above, in some embodiments, V₁ is chosen to be less than V₂, the cell operating voltage. In embodiments in which V₁ is less than V₂, lithium is not removed from the positive electrode because the salt decomposes at a lower voltage than at which the positive electrode can release lithium. During prelithiation, the cell voltage is maintained below the voltage at which the cathode can release lithium, so current can flow and prelithiate the negative electrode without removing lithium from the positive electrode. However, in some embodiments, prelithiation may proceed during the first charging of the cell. For example, V₁ may be continuously ramped from Vₒ (or other starting voltage) to V₂.

As lithium cations from the prelithiation salt are reduced at the anode, lithium is inserted into the anode. In one arrangement, as the anions are oxidized at the cathode, other reaction products, such as gas(es) are produced. Such gas(es) can be released from the cell. In other arrangements, there may be other reaction products such as liquid soluble products, which remain in solution. These may be removed from the cell when the prelithiation electrolyte is removed. If inert, the byproducts may remain in solution if the prelithiation electrolyte is not removed, but used as the standard electrolyte.

The prelithiation methods and materials described herein can be useful in cell configurations with several layers of stacked electrodes or jelly-rolled electrodes. The prelithiation solution goes into a preassembled cell and can penetrate wherever an electrolyte can penetrate. There is no impediment to prelithiation in any cell that is designed to undergo cycling. The method of prelithiation disclosed herein avoids some of the safety and cost issues that have made other prelithiation methods difficult to use in high-volume production. The distribution of current through the cell is very uniform as the cell cathode itself is used in the circuit instead of using an auxiliary electrode that is located outside of the electrode stack. In addition, in some embodiments, the composition of the cathode does not change during prelithiation as no lithium ions are removed from the cathode in the process.

### Examples

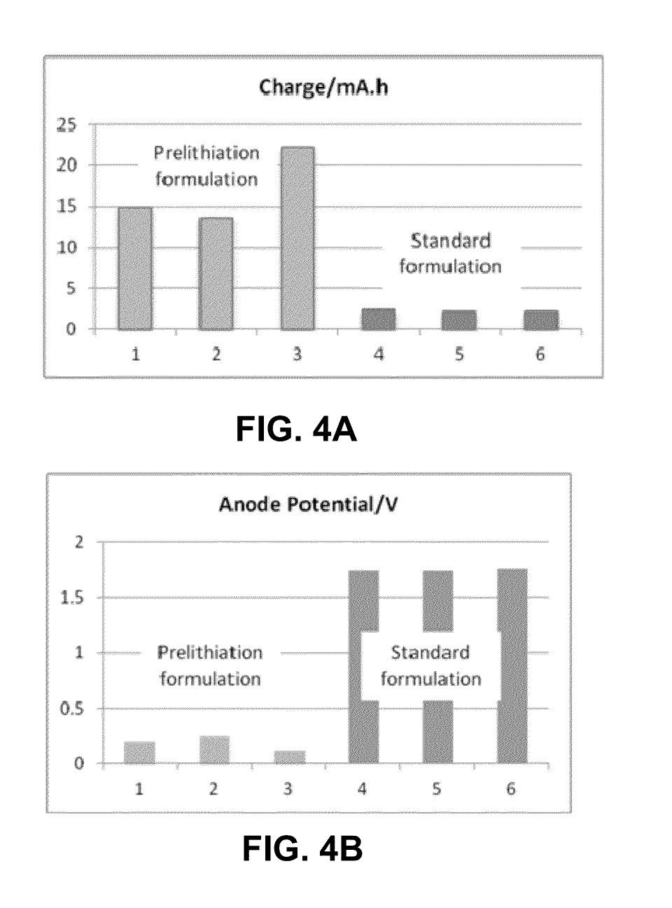

FIG. 4A is a graph that shows the capacity delivered to carbon/lithium cobalt oxide (LCO) Cells 1-3 with a constant current/constant voltage (CC/CV) charging protocol using a prelithiation solution. For comparison, Cells 4-6 are charged with the same protocol using a conventional electrolyte without the prelithiation salt.

FIG. 4B is a graph that shows the carbon negative-electrode potential (vs. Li/Li+) after the prelithiation protocol is finished. Cells 1-3 had the prelithiation solution formulation, and the negative electrode potentials below 250 mV indicate that a substantial amount of lithium has been driven into the material during prelithiation. By contrast, Cells 4-6, which did not have the prelithiation solution formulation, have negative electrode potentials above 1500 mV, which indicates that the graphitic electrodes are storing negligible amounts of lithium after the prelithiation protocol.

The prelithiation formulation increases the amount of charge passed through the cell at voltage bellow the voltage required to extract lithium from the cathode, i.e. the prelithiation salt is decomposed and lithium prelithiates the anode. The prelithiation is confirmed by the low potential reached by the anode in the cells with prelithiation formulation.

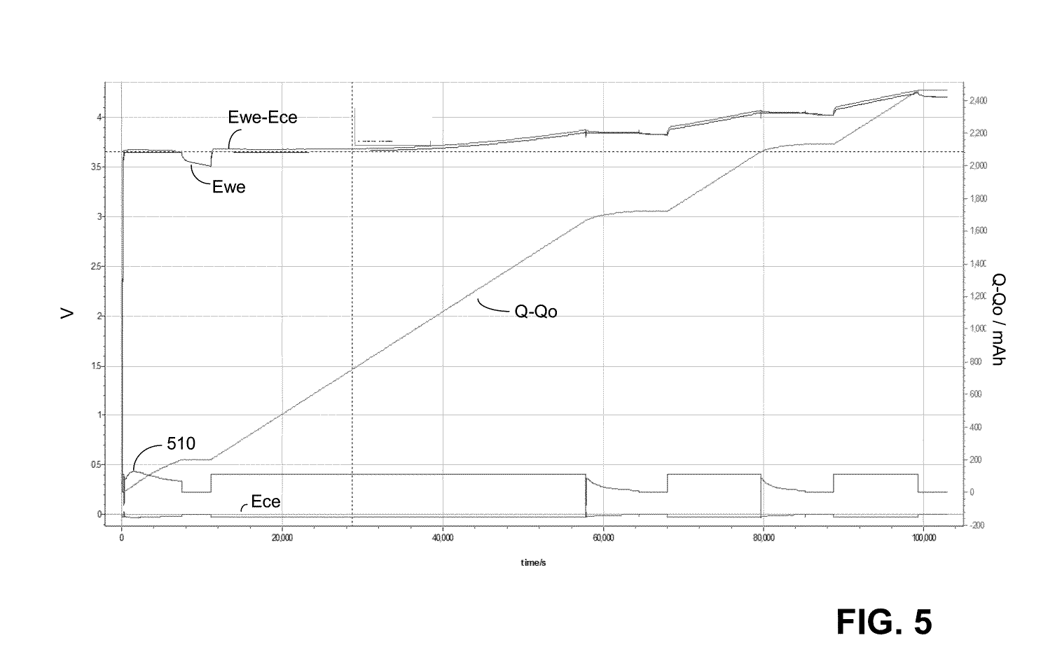

A prelithiation-formation charging protocol is shown in FIG. 5. A Si anode/LCO cathode cell was filled with a prelithiation electrolyte. The prelithiation electrolyte was a standard Li-ion electrolyte of carbonate type solvents and LiPF₆ salt, to which a prelithiation salt and additives were added. A constant current was applied in four charging steps, separated by constant voltage steps at 3.65, 3.85, 4.05 and 4.25V, the lattermost being the charging voltage limit of the cell. The following values are shown in the plot: left axis-Ewe (cathode voltage vs. Li reference) vs. time; Ece (anode voltage) vs. time; and Ewe-Ece (cell voltage) vs. time and right axis: Q-Qo (charge that passed through the system) and current (line 510).

It can be observed that during the first voltage hold, at 3.65V, the current (line 510) increases at first, reaches a peak and drops. The initial increase indicates that additional charge is injected in the system at a voltage which is too low for lithium to be extracted from the cathode. This additional charge increases cell capacity and is due to the decomposition of the prelithiation salt.

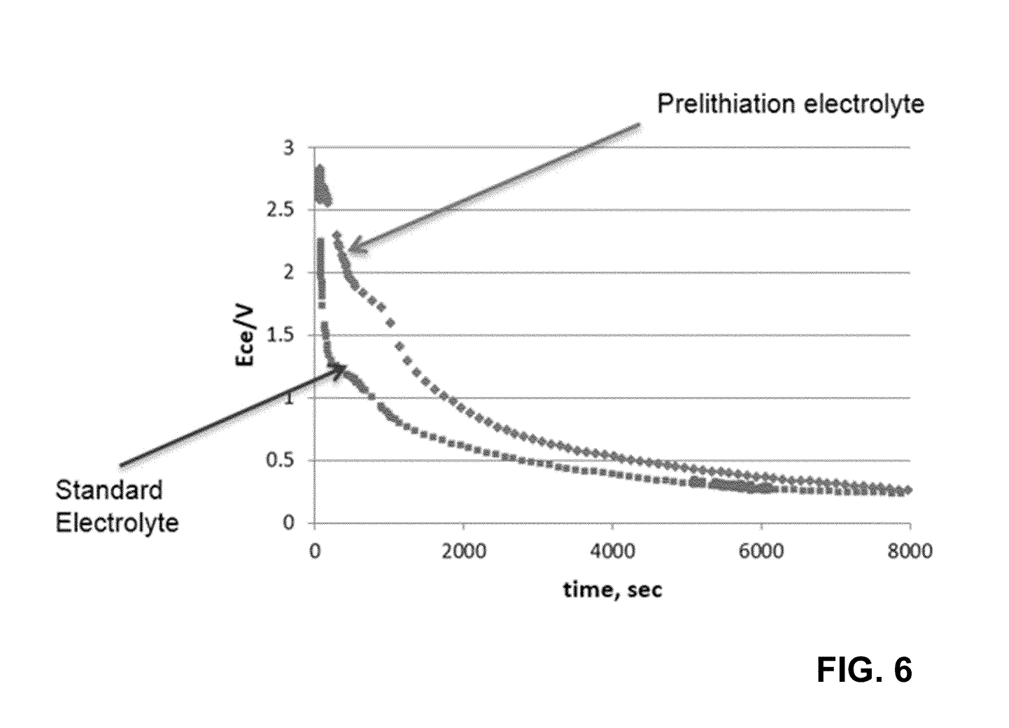

FIG. 6 shows the anode potential versus a Li/Li+ reference electrode in a three electrode cell during the first constant current charge (formation) in a standard (non-prelithiation) electrolyte and in a prelithiation electrolyte, as indicated. It is apparent that in the presence of the prelithiation electrolyte there is additional charge required to lower the voltage, or, in other words, additional reactions take place at the electrodes before typical charging starts.

Positive Electrode Materials

In one embodiment of the invention, any of a number of lithium containing compounds may be used. In a specific embodiment, the active material may be in the form of LiMO₂, where M is a metal e.g., LiCoO₂, LiNiO₂, and LiMnO₂. Lithium cobalt oxide (LiCoO₂) is a commonly used material for small cells but it is also one of the most expensive. The cobalt in LiCoO₂ may be partially substituted with Sn, Mg, Fe, Ti, Al, Zr, Cr, V, Ga, Zn, or Cu. Lithium nickel oxide (LiNiO₂) is less prone to thermal runaway than LiCoO₂, but is also expensive. Lithium manganese oxide (LiMnO₂) is the cheapest in the group of conventional materials and has relatively high power because its three-dimensional crystalline structure provides more surface area, thereby permitting more ion flux between the electrodes. Lithium iron phosphate (LiFePO₄) is also now used commercially as a positive electrode active material.

Examples of the positive active materials include: Li (M′_{X}M″_{Y})O₂, where M′ and M″ are different metals (e.g., Li(Ni_{X}Mn_{Y})O₂, Li(Ni_{1/2}Mn_{1/2})O₂, Li(Cr_{X}Mn_{1-X})O₂, Li(Al_{X}Mn_{1-X})O₂), Li(Co_{X}M_{1-X})O₂, where M is a metal, (e.g. Li(Co_{X}Ni_{1-X})O₂ and Li(Co_{X}Fe_{1-X})O₂), Li_{1-W}(Mn_{X}Ni_{Y}Co_{Z})O₂, (e.g. Li(Co_{X}Mn_{Y}Ni_{(1-X-Y)})O₂, Li(Mn_{1/3}Ni_{1/3}Co_{1/3})O₂, Li(Mn_{1/3}Ni_{1/3}Co_{1/3-X}Mg_{X})O2, Li(Mn_{0.4}Ni_{0.4}Co_{0.2})O₂, Li(Mn_{0.1}Ni_{0.1}Co_{0.8})O₂,) Li_{1-W}(Mn_{X}Ni_{X}Co_{1-2X})O₂, Li_{1-W} (Mn_{X}Ni_{Y}CoAl_{W})O₂, Li_{1-W}(Ni_{X}Co_{Y}Al_{Z})O₂ (e.g., Li(Ni_{0.8}Co_{0.15}Al_{0.05})O₂), Li_{1-W}(Ni_{X}Co_{Y}M_{Z})O₂, where M is a metal, Li_{1-W}(Ni_{X}Mn_{Y}M_{Z})O₂, where M is a metal, Li(Ni_{X}Mn_{Y}Cr_{2-X})O₄, LiM′M″₂O₄, where M′ and M″ are different metals (e.g., LiMn_{2-Y-Z}Ni_{Y}O₄, LiMn_{2-Y-Z}Ni_{Y}Li_{Z}O₄, LiMn_{1.5}Ni_{0.5}O₄, LiNiCuO₄, LiMn_{1-X}Al_{X}O₄, LiNi_{0.5}Ti_{0.5}O₄, Li_{1.05}Al_{0.1}Mn_{1.85}O_{4-z}F_{z}, Li₂MnO₃) Li_{X}V_{Y}O_{Z}, e.g. LiV₃O₈, LiV₂O₅, and LiV₆O₁₃. One group of positive active materials may be presented as LiMPO4, where M is a metal. Lithium iron phosphate (LiFePO₄) is one example in this group. Other examples include LiM_{X}M″_{1-X}PO₄ where M′ and M″ are different metals, LiFe_{X}M_{1-X}PO₄, where M is a metal (e.g., LiVOPO₄Li₃V₂(PO₄)₃), LiMPO₄, where M is a metal such as iron or vanadium. Further, a positive electrode may include a secondary active material to improve charge and discharge capacity, such as V₆O₁₃, V₂O₅, V₃O₈, MoO₃, TiS₂, WO₂, MoO₂, and RuO₂. In some arrangements, the positive electrode material includes LiNiVO₂.

Negative Electrode Materials

Negative electrode active materials that can be used with lithium-ion cells can be any material that can serve as a host material (i.e., can absorb and release) lithium ions. Examples of such materials include, but are not limited to graphite, natural or artificial, hard carbons, graphene, and combinations thereof. Silicon and silicon alloys are known to be useful as negative electrode materials in lithium cells. Examples include silicon alloys of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) and mixtures thereof. In some arrangements, mixtures of silicon or silicon alloys and carbon are used. In other arrangements, graphite, metal oxides, silicon oxides or silicon carbides can also be used as negative electrode materials. In one example, titanium oxide is used as a negative electrode material.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A prelithiation solution, comprising:
a solvent;
a lithium-based salt dissolved in the solvent to form the prelithiation solution;
wherein the prelithiation solution is configured to react electrochemically at a lithium-containing positive electrode at a first voltage;
and wherein lithium can be removed from the positive electrode at voltages at and above a second voltage that is higher than the first voltage.

2. The solution of claim 1 wherein the lithium-based salt is selected from the group consisting of lithium methoxide, lithium azide, lithium halides, lithium acetate, lithium acetate, lithium acetylacetonate, lithium amides, lithium acetylides, R—Li (R=alkyl and aryl), R₃ELi derivatives, where E=Si, Ge, Sn and R=alkyl or aryl, and combinations thereof.

3. The solution of claim 1, wherein the prelithiation solution further comprises an ion conducting lithium based-salt that does not decompose at the first voltage.

4. The solution of claim 3, wherein the ion conducting lithium-based salt is selected from lithium hexafluorophosphate (LiPF₆), lithium bis-trifluoromethanesulfonimide (LiTFSI), LiFSI, lithium tetrafluoroborate (LiBF₄), lithium hexafluoroarsenate monohydrate (LiAsF₆), lithium perchlorate (LiClO₄), lithium bis(oxalato)borate (LiBOB), lithium oxalyldifluoroborate (LiODFB), LiPF₃(CF2CF₃)₃ (LiFAP), LiBF₃(CF₂CF₃)₃ (LiFAB), LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), a lithium salt having a cyclic alkyl groups, and combinations thereof.

5. The solution of claim 1 wherein the solvent is electrochemically stable at the first voltage.

6. The solution of claim 1, wherein the solvent is electrochemically stable at the second voltage.

7. The solution of claim 1 wherein the solvent is selected from the group consisting of polar protic or aprotic solvents, cyclic or linear ethers, alkyl carbonates, amides, amines, esters, nitriles, gamma-butyrolactone, ionic liquids, and combinations thereof.

8. The solution of claim 1, wherein the solvent includes one or more cyclic carbonates, lactones, linear carbonates, ethers, nitrites, linear esters, amides, organic phosphates, organic compounds containing an S═O group, and combinations thereof.

9. The solution of claim 1, further comprising one additives to increase the solubility of the lithium-based salt.

10. The solution of claim 1 wherein the solution has a lithium content between about 0.01 and 25 wt %

11. The solution of claim 1 wherein the solution has a lithium content between about 0.01 and 10 wt %.

12. A prelithiation electrolyte, comprising:
a solvent;
a first lithium-based salt dissolved in the solvent, wherein the first lithium-based salt undergoes a decomposition onset at a first voltage;
a second lithium-based salt dissolved in the solvent, wherein the second lithium based salt is configured to be stable at a second voltage, higher than the first voltage.

13. The prelithiation electrolyte of claim 12, wherein the second voltage is at least 0.5V greater than the decomposition onset voltage.

14. The prelithiation electrolyte of claim 12, wherein the first lithium-based salt is selected from the group consisting of lithium methoxide, lithium azide, lithium halides, lithium acetate, lithium acetate, lithium acetylacetonate, lithium amides, lithium acetylides, R—Li (R=alkyl and aryl), R₃ELi derivatives, where E=Si, Ge, Sn and R=alkyl or aryl, and combinations thereof.

15. The prelithiation electrolyte of claim 12, wherein the second lithium-based salt is selected from the group consisting of lithium hexafluorophosphate (LiPF₆), lithium bis-trifluoromethanesulfonimide (LiTFSI), LiFSI, lithium tetrafluoroborate (LiBF₄), lithium hexafluoroarsenate monohydrate (LiAsF6), lithium perchlorate (LiClO₄), lithium bis(oxalato)borate (LiBOB), lithium oxalyldifluoroborate (LiODFB), LiPF₃(CF2CF₃)₃ (LiFAP), LiBF₃(CF₂CF₃)₃ (LiFAB), LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), a lithium salt having a cyclic alkyl groups, and combinations thereof.

16. A method of prelithiating an electrochemical cell, comprising the steps of:
providing an anode configured to absorb lithium ions, a cathode, and a separator disposed between the anode and the cathode;
soaking the separator with a prelithiation solution according to claim 1;
providing a first voltage between the anode and the cathode to thereby decompose the lithium-based salt and provide lithium ions to the anode.

17. The method of claim 16, wherein the anode comprises an active material is selected from the group consisting of carbon, silicon, silicides, silicon alloys, silicon oxides, silicon nitrides, germanium, tin, titanium oxide, and combinations thereof.

18. The method of claim 16, wherein the cathode comprises lithium and wherein lithium can be removed from the cathode at voltages at and above a second voltage wherein the first voltage is lower than a second voltage.

19. The method of claim 18, wherein the cathode comprises an active material selected from the group consisting of lithium iron phosphate (LFP), LiCoO₂, LiMn₂O₄, lithium nickel cobalt aluminum oxide (NCA), and lithium nickel cobalt manganese oxide (NCM).

20. The method of claim 16, further comprising bringing the electrochemical cell to its operating voltage without first removing the prelithiation solution.

21. A preassembled lithium-ion electrochemical cell, comprising:
an anode;
a cathode;
a separator disposed between the anode and the cathode;
a package containing the anode, the cathode, and the separator, the package having an opening through which a liquid can be poured; and
a prelithiation solution according to claim 1, the solution soaked into at least the separator.
